(19) United States
(12) Patent Application Publication
(10) Pub. No.: US 2018/0201530 A1
(43) Pub. Date: Jul. 19, 2018

(54) WATERSHED STORMWATER MANAGEMENT THROUGH A BIOBASED BIODEGRADABLE NUTRIENT AND SEDIMENT RETAINING WATER FILTRATION TUBE WITH EROSION CONTROL

(71) Applicant: Joseph Greco, Atlantic, PA (US)

(72) Inventor: Joseph Greco, Atlantic, PA (US)

(21) Appl. No.: 15/920,476

(22) Filed: Mar. 14, 2018

Related U.S. Application Data
(63) Continuation-in-part of application No. 15/616,838, filed on Jun. 7, 2017.
Application No. 15/616,838 is a continuation-in-part of application No. 14/692,056, filed on Apr. 21, 2015.
(60) Provisional application No. 62/346,972, filed on Jun. 7, 2016.
(60) Provisional application No. 61/982,596, filed on Apr. 22, 2014.

(51) Int. Cl. C02F 3/32; B01J 20/24; B01J 20/28; C02F 1/00; E03F 1/00

(52) U.S. Cl. CPC C02F 3/32; B01J 20/24; B01J 20/28042; C02F 2103/001; C02F 1/004; E03F 1/001; E03F 1/002; B01J 20/28011

(57) ABSTRACT

Disclosed are a method, device and system of a watershed stormwater management through a biobased biodegradable nutrient and sediment retaining water filtration tube with erosion control. In one aspect, a method of watershed stormwater management system includes forming the biobased filtration tube from a nontoxic renewable domestic agricultural material. The method ensures a diameter of the biobased filtration tube to approximately 10% greater than a field deployment to prevent shrinkage caused by ambient conditions, retains a sedimentary pollutant, and places the biobased filtration tube along the perimeter of a site. A filter material of the biobased filtration tube helps preventing high concentrations of sedimentary pollutant from getting into the streams. The biobased filtration tube captures and treats stormwater that runs off as sheet flow. The biobased filtration tube is utilized in the vegetated form. Vegetation grew into a slope at the site anchors the biobased filtration tube in an environment.

### CLAIMS OF PRIORITY

This patent application is a Continuation-In-Part application and claims priority from, and hereby incorporates by reference and claims priority from the entirety of the disclosures of the following cases and each of the cases on which they depend and further claim priority or incorporate by reference:
1. Co-pending U.S. utility patent application Ser. No. 15/616,838, titled ‘SYSTEM AND METHOD FOR MANUFACTURING EROSION CONTROL SWITCHGRASS FILTER SOCKS’ filed on Jun. 7, 2017, which further depends on:
   a. U.S. Provisional patent application No. 62/346,972, titled ‘SWITCHGRASS EROSION CONTROL FILTER SOCK PROCESS’ filed on Jun. 7, 2016.
2. Co-pending U.S. utility patent application Ser. No. 14/692,056, titled ‘BIODEGRADABLE RUNOFF FILTER’ filed on Apr. 21, 2015, which further depends on:
   a. U.S. Provisional patent application No. 61/982,596, titled ‘SWITCHGRASS FILLED FILTER SOCK’ filed on Apr. 22, 2014.

### FIELD OF TECHNOLOGY

This disclosure relates generally to stormwater management system and, more particularly, to a system, a method, and a device of watershed stormwater management through a biobased biodegradable nutrient and sediment retaining water filtration tube with erosion control.

### BACKGROUND

A stormwater is water that originates during precipitation events and/or snow/ice melts. The stormwater can soak into the soil (e.g., infiltrate), be held on the surface and evaporate, and/or runoff and end up in nearby streams, rivers, and/or other water bodies (e.g., surface water). In natural landscapes such as forests, fires and human activity can impede absorption of stormwater into the ground. As a result, unmanaged stormwater can create two major issues: one related to the volume and timing of runoff water (e.g., flooding) and the other related to potential contaminants that the water is carrying (e.g., water pollution).

Conventional mechanisms to control stormwater may include utilizing wood-based compost materials comprising of mulch and wood chips. Other conventional methods include unsightly silt fences and tubes made of plastics, metals, and other unnatural materials used to control stormwater. The use of wood-based compost materials may cause unintended additional contamination through leaching and ecosystem strain, resulting in added pollution into precious waterways and streams. The wood-based compost materials include mulch and soft and hard wood chips. Mulch has residual pesticides as well as nutrients such as phosphorus, nitrites and nitrates. Wood chips contain organic tartaric acids, gases, metals such as arsenic originating from bark of the tree. While conventional wood-based compost filters work as diversion filters, it may be insufficient to retain nutrients, acids, heavy metals such as arsenic, allowing polluted water to pass through it, thereby mixing with waterways and streams and polluting it further.

### SUMMARY

Disclosed are a method, a device and/or a system of watershed stormwater management through a biobased biodegradable sediment retaining water filtration tube with erosion control.

In one aspect, a method of a watershed stormwater management system includes forming a sediment retaining water filtration (hereinafter SRWF) tube from a nontoxic renewable domestic agricultural material including from a plant, an animal, a marine material, and/or a forestry material. The method of the watershed stormwater management system includes manufacturing a diameter of the biobased filtration tube that is approximately 10% greater than a field deployment to allow and account for shrinkage caused by ambient conditions to allow or account for shrinkage caused by ambient conditions.

Further, the method of the watershed stormwater management system includes retaining a nutrients and sedimentary pollutant including a phosphate, a suspended solid, a tannic acid, a nitrate, and/or a motor oil through a nontoxic filter material in the biobased filtration tube. The nontoxic filter material in the biobased filtration tube prevents the nutrients and the sedimentary pollutant from getting into streams causing growth of algae and green plants in waterways, lakes, and oceans. The biobased filtration tube has a shape which is an oval shape and/or a round shape in cross section. The biobased filtration tube provides a three-dimensional filter to retain nutrients and sedimentary pollutant and other pollutants while purifying water and permitting purified water to flow through the biobased filtration tube.

In addition, the method of the watershed stormwater management system includes placing the biobased filtration tube along the perimeter of a site and/or at intervals along a slope to capture and treat stormwater that runs off as a sheet flow.

The biobased filtration tube has a greater surface area contact with soil than other sediment control devices to reduce a potential for runoff to create rills under the biobased filtration tube and to create channels for carrying unfiltered sediment. The biobased filtration tube is operable in a vegetated form and/or an un-vegetated form. Vegetation grows into the slope anchoring the biobased filtration tube in an environment when the biobased filtration tube is utilized in the vegetated form.

The method of a watershed stormwater management system may include reducing flow velocity and soil erosion by placing the biobased filtration tube perpendicular to the stormwater flow. The watershed stormwater management system may be usable on a pavement as inlet protection for storm drains and to slow water flow in small ditches. The biobased filtration tube nontoxic fill material may be spreadable around the site as a soil material when a project is completed and the biobased filtration tube is sliced. A filter mesh fabric and/or a cotton fabric of the biobased filtration tube may be naturally degraded into a surrounding environment.

The biobased filtration tube may be installable without need of trenching. The biobased filtration tube may be stackable on top of other biobased filtration tubes. The biobased filtration tube may be filled with the nontoxic filter material with a particle size optimized to reduce velocity while trapping unwanted pollutants. The biobased filtration tube may be assembled by tying a knot and/or a zip tie at one end of a mesh fabric and/or a cotton fabric, filling the biobased filtration tube with the nontoxic filter material, and securing an opposite end once a desired length is reached. The biobased filtration tube may be anchored to the slope through a set of stakes driven through a center, and/or on both sides, of the biobased filtration tube at regular intervals. The biobased filtration tube may be used in conjunction with a hydro-seeding process, a matting/netting process, and/or a compost blanket process.

In another aspect, a watershed stormwater management system includes a biobased filtration tube comprised of a herbaceous perennial plant such as switchgrass material. The biobased filtration tube is 100% composed of a nontoxic biological product and/or a nontoxic renewable domestic agricultural material including from a plant, an animal, a marine material, and/or a forestry material. The biobased filtration tube is sustainable in a field deployment without minimal degradation for at least ten (10) months for the mesh fabric and at least five (5) months for the cotton fabric across extreme conditions of snow, rain and temperature range between 20° F. and 100° F. The biobased filtration tube is manufactured with a diameter that is approximately 10% greater than the field deployment to allow and account for shrinkage caused by ambient conditions.

The biobased filtration tube may be an alternative to a wood-based compost in a furnishing, a placement, a maintenance of a wood-based compost filter sock erosion and/or a sedimentation pollution control system. The biobased filtration tube may be constructed in various sizes from the diameter of at least 4″ inches and/or above. The biobased filtration tube may be storable without installation for at least 8 months on a pallet in external conditions without degradation. The biobased filtration tube may retain sedimentary pollutant including a phosphate, a suspended solid, a tannic acid, a nitrate, and/or a motor oil through a non-toxic filter material. The biobased filter tube may be enriched and/or vegetated by incorporating seeds with the filter material. The seeds may grow the roots in the ground making the tube more stable.

The nontoxic filter material in the biobased filtration tube may prevent the high concentration of the sedimentary pollutant from getting into the streams causing growth of algae and green plants in waterways, lakes, and oceans. The biobased filtration tube may be constructed from a 100% cotton biopreferred sock and/or a photo-degradable material which naturally degrades over-time. The biobased filtration tube may be constructed of a sturdy polypropylene geotextile woven fabric made from biodegradable material and/or cotton fabric to control erosion, contain sediment, and retain sedimentary pollutant in disturbed areas. The biobased filtration tube may be a mesh and/or cotton tube filled with a non-toxic biobased material and may be placed perpendicular to sheet-flow runoff.

The biobased filtration tube may be used instead of a traditional sediment and an erosion control tool as a silt fence, a straw bale barrier and a mulch sock. The biobased filtration tube may be placed along the perimeter of a site, and/or at intervals along a slope to capture and treat stormwater that runs off as a sheet flow. The biobased filtration tube may be flexible, fillable, and easily movable into position to facilitate placement on steep and rocky slopes where installation of other erosion control tools is not feasible.

The biobased filtration tubes may be placeable adjacent to each other and perpendicular to stormwater flow to reduce flow velocity and soil erosion. The biobased filtration tube may be manufactured through a process that converts a nontoxic herbaceous perennial plant and/or switchgrass agricultural bi-product into a dry bulk density biomass of at least 1.6 g/cm3 through a smooth compaction roller and forming a porous sheet having a thickness of approximately 1 inch that is rolled into a form of the biobased filtration tube.

In yet another aspect, a method of a watershed stormwater management system includes forming a biobased filtration tube from a nontoxic renewable domestic agricultural material including from a plant, an animal, a marine material, and/or a forestry material. The method of a watershed stormwater management system includes ensuring a diameter of the biobased filtration tube is approximately 10% greater than a field deployment to allow and account for shrinkage caused by ambient conditions.

The method of a watershed stormwater management system includes retaining a sedimentary pollutant including a phosphate, a suspended solid, a tannic acid, a nitrate, and/or a motor oil through a filter material in the biobased filtration tube. The nontoxic filter material in the biobased filtration tube prevents the high concentrations of the sedimentary pollutant from getting into the streams causing growth of algae and green plants in waterways, lakes, and oceans. The biobased filtration tube has a shape which is an oval shape and/or a round shape in cross section. The biobased filtration tube provides a three-dimensional nontoxic filter to retain sediment and other pollutants while purifying water and permitting purifying water to flow through the biobased filtration tube.

Further, the method of a watershed stormwater management system includes placing the biobased filtration tube along the perimeter of a site, and/or at intervals along a slope to capture and treat stormwater that runs off as sheet flow. In addition, the method of a watershed stormwater management system includes reducing flow velocity and soil erosion by placing the biobased filtration tube perpendicular to stormwater flow.

In one more aspect, the biobased filtration tube may be manufactured using a biodegradable poly mesh fabric and/or a cotton fabric. The biobased filtration tube manufactured from the biodegradable poly mesh fabric and/or cotton fabric may be stacked on top of each other. The biodegradable poly mesh fabric, wool, and/or cotton fabric may be used in combination by placing the biobased filtration tube along the perimeter of a site, and/or at intervals along a slope to capture and treat stormwater that runs off as sheet flow in an alternate arrangement. Furthermore, the biobased filtration tube maybe porous, non-porous, and/or semi-porous tube and/or sock.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an overview of a watershed stormwater management system illustrating a biobased filtration tube retaining nutrients and sedimentary pollutants inside the tube and passage of filtered water to prevent the nutrients and/or pollutants getting into a waterbody, according to one embodiment.

FIG. 2 is a structural view of the biobased filtration tube of FIG. 1 illustrating the formation of the biobased filtration tube, according to one embodiment.

FIG. 3A is a conceptual view of the biobased filtration tube of FIG. 1 illustrating the biobased filtration tube retaining the nutrients and/or sedimentary pollutant from a sheet flow, according to one embodiment.

FIG. 3B is another conceptual view of the biobased filtration tube of FIG. 1 illustrating the biobased filtration tube retaining the nutrients and/or the sedimentary pollutants from getting into the storm drain inlet on a pavement, according to one embodiment.

FIG. 4 is a stacking view of the biobased filtration tube of FIG. 1 illustrating the loading of the biobased filtration tube on a pallet, according to one embodiment.

FIG. 5 is a table view of the biobased filtration tube of FIG. 1 showing an analytical test result of the sedimentary pollutant retained by the biobased filtration tube, according to one embodiment.

FIG. 6 is a process flow of manufacturing of the biobased filtration tube of FIG. 1, according to one embodiment.

FIG. 7 is a process flow for application of watershed stormwater management system using the biobased filtration tube of FIG. 1, according to one embodiment.

FIG. 8 is an overview of the watershed stormwater management system illustrating the biobased filtration tube of FIG. 1, in an alternate implementation for retaining nutrients and sedimentary pollutants inside the tube and allowing passage of filtered water to prevent the nutrients and/or pollutants getting into a waterbody when placed in the direction of water flow, according to one embodiment.

FIG. 9 is a conceptual view of the biobased filtration tube of FIG. 1 illustrating the biobased filtration tube retaining the nutrients and/or sedimentary pollutant from a sheet flow when placed in the direction of water flow, according to one embodiment.

FIG. 10 is another conceptual view in an alternative implementation of the biobased filtration tube of FIG. 1 illustrating the biobased filtration tube retaining the nutrients and/or the sedimentary pollutants from getting into the storm drain inlet on a pavement, according to one embodiment.

Other features of the present embodiments will be apparent from the accompanying drawings and from the detailed description that follows.

### DETAILED DESCRIPTION

Example embodiments, as described below, may be used to provide a method, a system and/or a device of watershed stormwater management through a biobased biodegradable sediment retaining water filtration tube with erosion control.

In one embodiment, a method of a watershed stormwater management system 150 includes forming a biobased filtration tube 102 from a nontoxic renewable domestic agricultural material (e.g., biodegradable filter mesh fabric 206, cotton fabric) including from a plant, an animal, a marine material, and/or a forestry material. The method of the watershed stormwater management system 150 includes ensuring a diameter of the biobased filtration tube 102 is approximately 10% greater than a field deployment to allow and account for shrinkage caused by ambient conditions.

Further, the method of the watershed stormwater management system 150 includes retaining a sedimentary pollutant 104 including a phosphate, a suspended solid, a tannic acid, a nitrate, and/or a motor oil through a nontoxic filter material in the biobased filtration tube 102. The nontoxic filter material 204 in the biobased filtration tube 102 prevents the high concentration of the sedimentary pollutant 104 and/or nutrients 104B from getting into the streams causing growth of algae and green plants in waterbody 116 (e.g., waterways, lakes, and oceans etc.). The biobased filtration tube 102 has a shape which is an oval shape, a round shape, triangular, rectangular and/or any polygonal shape in cross section. The biobased filtration tube 102 provides a three-dimensional filter to retain nutrients 104B, sedimentary pollutant(s) 104 and other pollutants while purifying water and permitting purified water and/or filtered water 120 (e.g., stormwater flow 110) to flow through the biobased filtration tube 102.

In addition, the method of the watershed stormwater management system 150 includes placing the biobased filtration tube 102 along the perimeter of a site 106 and/or at intervals along a slope 108 to capture and treat stormwater (e.g., stormwater flow 110) that runs off as a sheet flow 112. The biobased filtration tube 102 has a greater surface area contact with soil than other sediment control devices to reduce a potential for runoff to create rills under the biobased filtration tube 102 and to create channels for carrying unfiltered sediment (e.g., sedimentary pollutant 104). The biobased filtration tube 102 is operable in a vegetated form and/or an un-vegetated form. Vegetation grows into the slope 108 anchoring the biobased filtration tube 102 in an environment when the biobased filtration tube 102 is utilized in the vegetated form.

The method of a watershed stormwater management system 150 may include reducing flow (e.g., stormwater flow 110) velocity and soil erosion by placing the biobased filtration tube 102 perpendicular to the stormwater flow 110. The watershed stormwater management system 150 may be usable on a pavement 302 as inlet protection for storm drains and to slow water flow in small ditches. The biobased filtration tube 102 nontoxic filter material may be spreadable around the site 106 as a soil material when a project is completed and the biobased filtration tube 102 is sliced. A filter mesh and/or cotton fabric (e.g., biodegradable filter mesh fabric 206, cotton fabric) of the biobased filtration tube 102 may be naturally degraded into a surrounding environment.

The biobased filtration tube 102 may be installable without need of trenching. The biobased filtration tube 102 may be stackable on top of other biobased filtration tubes 102. The biobased filtration tube 102 may be filled with the nontoxic filter material 204 with a particle size optimized to reduce flow (e.g., stormwater flow 110) velocity while trapping unwanted pollutants (e.g., sedimentary pollutant 104). The biobased filtration tube 102 may be assembled by tying a knot and/or a zip tie at one end (e.g., closed end 202) of a mesh and/or cotton sock (e.g., biobased filtration tube 102), filling the biobased filtration tube 102 with the nontoxic filter material 204, and securing an opposite end (e.g., open end 208) once a desired length is reached. The biobased filtration tube 102 may be anchored to the slope 108 through a set of stakes 114 driven through a center of, and/or on both sides of, the biobased filtration tube 102 at regular intervals. The biobased filtration tube 102 may be used in conjunction with a hydro-seeding process, a matting/netting process, and/or a compost blanket process.

In another embodiment, a watershed stormwater management system 150 includes a biobased filtration tube 102 comprised of nontoxic herbaceous perennial plant and/or switchgrass material (e.g., filter material 204). The biobased filtration tube 102 is 100% composed of a nontoxic biological product (e.g., filter material 204) and/or a renewable domestic agricultural material (e.g., biodegradable filter mesh fabric 206) including from a plant, an animal, a marine material, and/or a forestry material. The biobased filtration tube 102 is sustainable in a field deployment without minimal degradation for at least ten (10) months for the mesh fabric and at least five (5) months for the cotton fabric across extreme conditions of snow, rain and temperature range between 20° F. and 100° F. The biobased filtration tube 102 is manufactured with a diameter that is approximately 10% greater than the field deployment to prevent shrinkage caused by ambient conditions.

The non-toxic biobased filtration tube 102 may be an alternative to compost in a furnishing, a placement, a maintenance of a compost filter sock erosion and/or a sedimentation pollution (e.g., sedimentary pollutant 104) control system. The biobased filtration tube 102 may be constructed in various sizes from the diameter of 4″ inches and/or above. The biobased filtration tube 102 may be storable without installation for at least 8 months on a pallet 402 in external conditions without degradation. The biobased filtration tube 102 may retain sedimentary pollutant 104 including a phosphate, a suspended solid, a tannic acid, a nitrate, and/or a motor oil through a non-toxic filter material 204.

The non-toxic filter material 204 in the biobased filtration tube 102 prevents the high concentration of the sedimentary pollutant 104 from getting into the streams causing growth of algae and green plants in the waterbody 116 (e.g., waterways, lakes, and oceans). The biobased filtration tube 102 may be constructed from a 100% cotton biopreferred sock and/or a photo-degradable material which naturally degrades over-time. The biobased filtration tube 102 may be constructed of a sturdy polypropylene geotextile woven fabric and/or cotton fabric to control erosion, contain sediment, and retain sedimentary pollutant in disturbed areas. The biobased filtration tube 102 may be a mesh tube and/or cotton tube (e.g., biobased filtration tube 102) filled with a nontoxic biobased material (e.g., filter material 204) placed perpendicular to sheet-flow (e.g., sheet flow 112) runoff. The biodegradable filter sock (e.g., biobased filtration tube 102) may be made from a biodegradable mesh that is water permeable and is photodegradable and/or biobased cotton. This may allow the user to leave the biodegradable filter sock (e.g., biobased filtration tube 102) in a specific location to filter runoff and eventually decay into environment friendly materials.

The biobased filtration tube 102 may be used instead of traditional sediment (e.g., sedimentary pollutant 104) and an erosion control tool, such as a silt fence, a straw bale barrier and a mulch sock. The biobased filtration tube 102 may be placed along the perimeter of a site 106, and/or at intervals along a slope 108 to capture and treat stormwater (e.g., stormwater flow 110) that runs off as a sheet flow 112. The biobased filtration tube 102 may be flexible, fillable, and easily movable into position to facilitate placement on steep and rocky slopes where installation of other erosion control tools is not feasible.

The biobased filtration tubes 102 may be placed adjacent to each other and perpendicular to stormwater flow 110 to reduce flow (e.g., stormwater flow 110) velocity and soil erosion. The biobased filtration tube 102 may be manufactured through a process that converts a nontoxic herbaceous perennial plant and/or switchgrass agricultural bi-product (e.g., filter material 204) into a dry bulk density biomass of at least 1.6 g/cm3 through a smooth compaction roller and forming a porous sheet having a thickness of approximately 1 inch that is rolled into a form of the biobased filtration tube 102.

In yet another embodiment, a method of a watershed stormwater management system 150 includes forming a biobased filtration tube 102 from a nontoxic renewable domestic agricultural material (e.g., filter material 204) including from a plant, an animal, a marine material, and/or a forestry material. The method of a watershed stormwater management system 150 includes ensuring a diameter of the biobased filtration tube 102 is approximately 10% greater than a field deployment to allow and account for shrinkage caused by ambient conditions.

The method of a watershed stormwater management system 150 includes retaining a sedimentary pollutant 104 including a phosphate, a suspended solid, a tannic acid, a nitrate, and/or a motor oil through a filter material 204 in the biobased filtration tube 102. The filter material 204 in the biobased filtration tube 102 prevents the high concentrations of the sedimentary pollutant 104 from getting into the streams causing growth of algae and green plants in the waterbody 116 (e.g., waterways, lakes, and oceans etc.). The biobased filtration tube 102 has a shape which is an oval shape and/or a round shape in cross section. The biobased filtration tube 102 provides a three-dimensional filter to retain sediment (e.g., sedimentary pollutant 104) and other pollutants while purifying water and permitting purifying water (e.g., stormwater flow 110) to flow through the biobased filtration tube 102.

Further, the method of a watershed stormwater management system 150 includes placing the biobased filtration tube 102 along the perimeter of a site 106, and/or at intervals along a slope 108 to capture and treat stormwater (e.g., stormwater flow 110) that runs off as sheet flow 112. In addition, the method of a watershed stormwater management system 150 includes reducing flow (e.g., stormwater flow 110) velocity and soil erosion by placing the biobased filtration tube 102 perpendicular to the stormwater flow 110.

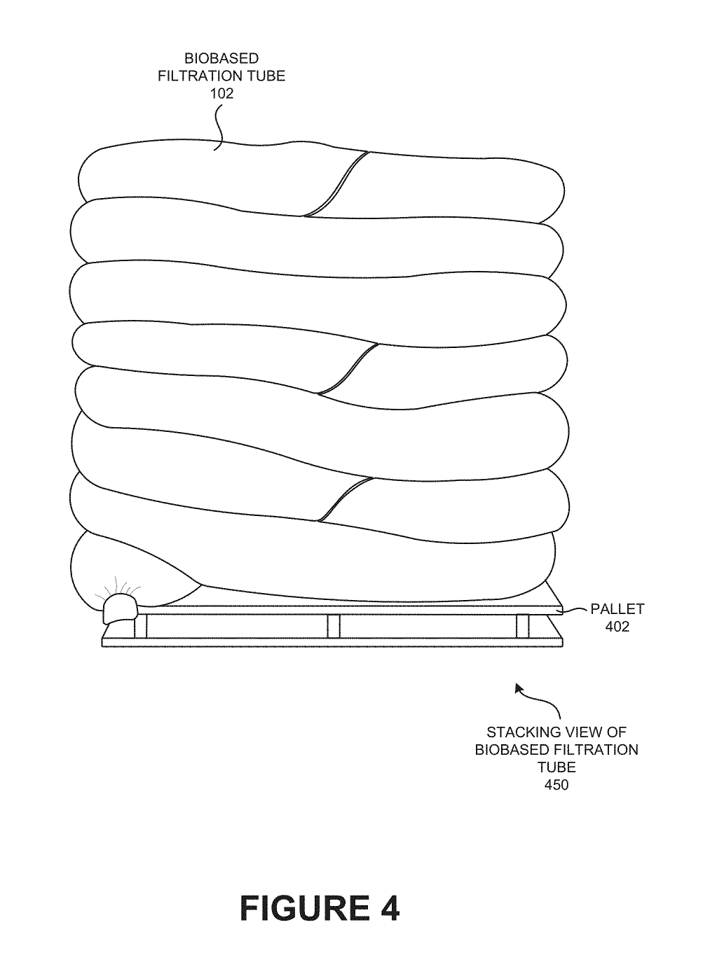

In one more example embodiment, the biobased filtration tube 102 may be manufactured using a biodegradable poly mesh fabric and/or a cotton fabric. The biobased filtration tube 102 manufactured from the biodegradable poly mesh fabric (e.g., biodegradable filter mesh fabric 206) and/or cotton fabric may be stacked on top of each other as shown in FIG. 4. The biodegradable poly mesh fabric (e.g., biodegradable filter mesh fabric 206) and/or cotton fabric may be used in combination by placing the biobased filtration tube 102 along the perimeter of a site, and/or at intervals along a slope 108 to capture and/or treat stormwater (e.g., stormwater flow 110) that runs off as sheet flow 112 in an alternate arrangement.

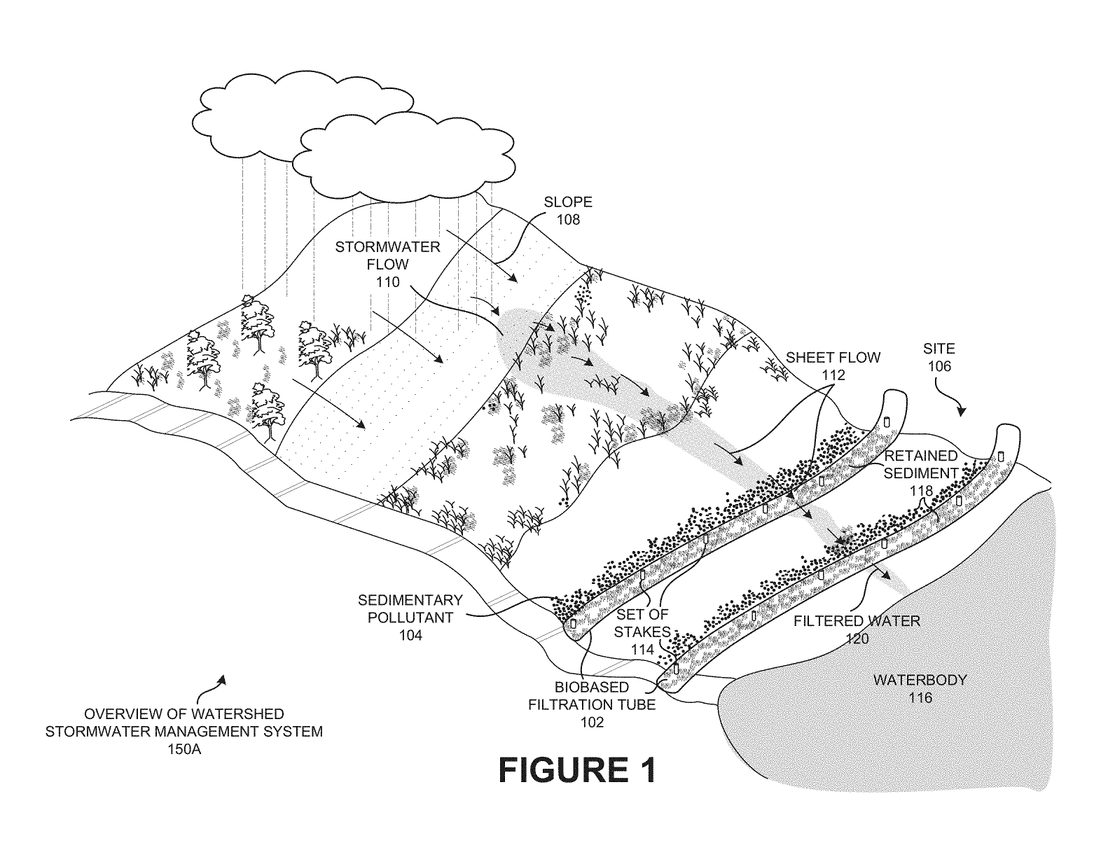

FIG. 1 is an overview of a watershed stormwater management system 150 illustrating a biobased filtration tube 102 retaining nutrients and/or sedimentary pollutant(s) 104 inside the tube and passage of filtered water 120 to prevent the nutrients and/or pollutants getting into a waterbody 116, according to one embodiment. Particularly, FIG. 1 illustrates a biobased filtration tube 102, a sedimentary pollutant(s) 104, a site 106, a slope 108, a stormwater flow 110, a sheet flow 112, a set of stakes 114, a waterbody 116, a retained sediment(s) 118, and purified water (e.g., filtered water 120), according to one embodiment.

The biobased filtration tube 102 may be a hollow elongated cylinder formed using a nontoxic renewable domestic agricultural material (e.g., biodegradable filter mesh fabric 206, cotton fabric) for filtering and/or retaining the sedimentary pollutant(s) 104 from flowing into the waterbody 116. The biobased filtration tube 102 may be composed in the form of a filter sock filled with nontoxic biobased material (e.g., filter material 204). The nontoxic renewable domestic agricultural material (e.g., biodegradable filter mesh fabric 206, cotton fabric) such as a plant, an animal, a marine material, and/or a forestry material may be used to form the biobased filtration tube 102. The nontoxic filtration media of the biobased filtration tube 102 may help retain the sedimentary pollutant(s) 104 and other pollutants flowing with stormwater (e.g., stormwater flow 110) and prevent it from getting into the streams and/or waterbody 116 (e.g., stream, waterway, lake, ocean), according to one embodiment.

The biobased filtration tube 102 may help prevent growth of algae and/or green plants in the waterbody 116 by restricting the inflow of high concentrations of sedimentary pollutant(s) 104 into the waterbody 116. The biobased filtration tube 102 may provide a three-dimensional filter to retain the sedimentary pollutant(s) 104 and other pollutants while purifying water at the same time. The biobased filtration tube 102 may allow purified water (e.g., filtered water 120) to flow through it, according to one embodiment.

The biobased filtration tube 102 may help prevent soil erosion and/or reduce runoff by limiting rainwater (e.g., stormwater flow 110) velocity and filtering out sand and/or sedimentary pollutant(s) 104 by keeping it in place and preventing it from getting washed away. The biobased filtration tube 102 may capture and treat stormwater (e.g., stormwater flow 110) that runs off over a slope 108 and/or along the perimeter of a site 106 when placed perpendicular to the stormwater flow 110, according to one embodiment.

In another embodiment, the biobased filtration tube 102 may be constructed from cotton biopreferred sock and/or a photo-degradable material that may naturally degrade over time. The biobased filtration tube 102 may be filled with nontoxic filter material 204 designed to optimize trapping of unwanted pollutants while allowing purified water (e.g., filtered water 120) to flow through it, according to one embodiment.

In one more embodiment, the biobased filtration tube 102 may be constructed from a sturdy polypropylene geotextile woven fabric and/or cotton fabric engineered specifically to control erosion, contain sediment (e.g., retained sediment 118), and/or retain sedimentary pollutant 104 in disturbed areas (e.g., construction site, rainstorm, areas at risk of flooding, soil erosion, etc.), according to one embodiment.

In a further embodiment, the biobased filtration tube 102 may be manufactured by converting the nontoxic herbaceous perennial plant and/or switchgrass agricultural bi-product into a dry bulk density biomass of at least 1.6 g/cm3 through a smooth compaction roller, and forming a porous sheet of approximately 1 inch thick rolled into a form of an elongated cylindrical tube, according to one embodiment.

The sedimentary pollutant(s) 104 may be a naturally occurring undesired material broken down by processes of weathering and/or erosion, which flows with stormwater (e.g., stormwater flow 110) by the force of gravity towards an area of low altitude. The sedimentary pollutant(s) 104 may include a phosphate, a suspended solid, a tannic acid, a nitrate, and/or a motor oil, etc. In addition, the sedimentary pollutant(s) 104 may include eroded soil, debris from the surrounding landscape, clay particles, mud, and boulders, etc. The sedimentary pollutant(s) 104 may cause growth of algae and green plants in waterbody 116 due to increased concentration of suspended solids in stormwater (e.g., stormwater flow 110) entering into the waterbody 116, according to one embodiment.

The site 106 may be an area of ground and/or location on which the biobased filtration tube 102 is placed to prevent the sedimentary pollutant(s) 104 from entering into the waterbody 116. The site 106 may include a construction site, an area affected by rainstorm, areas at risk of flooding, mining area, and/or soil erosion site, etc. where the biobased filtration tube 102 may be placed to retain the sedimentary pollutant(s) 104, according to one embodiment.

The slope 108 may be a measure of the steepness and/or an inclined part of a geographical area (e.g., a hill, terrace farm, etc.) through which the stormwater (e.g., stormwater flow 110) flows. The stormwater (e.g., stormwater flow 110) may flow from higher to lower altitudes through the slope 108 towards the waterbody 116, according to one embodiment.

The stormwater flow 110 may be a continuous current and/or stream of water that originates during precipitation events and snow/ice melt from the slope 108 towards the waterbody 116. The stormwater flow 110 may cause the runoff water to flow through the slope 108 from higher to lower altitudes towards the waterbody 116 along with the sedimentary pollutant(s) 104, according to one embodiment.

The sheet flow 112 may be an overland flow and/or a downslope movement of water taking the form of a thin, continuous film over relatively smooth soil and/or rock surfaces. The sheet flow 112 may occur in places having no defined channels, and the flood water may spread out over a large area at a uniform depth. The biobased filtration tube 102 may be placed along the slope 108 to capture and treat stormwater (e.g., stormwater flow 110) that runs off as a sheet flow 112, according to one embodiment.

The set of stakes 114 may be a group of strong wooden, biobased, and/or metal posts with a point at one end (e.g., closed end 202 and/or open end 208) that may be driven into the ground to support the biobased filtration tube 102. The set of stakes 114 may allow the biobased filtration tube 102 to remain in place even during strong currents of surface runoff, thereby retaining sedimentary pollutant(s) 104, according to one embodiment.

The waterbody 116 may be a natural and/or artificial accumulation of water, generally on a planet's surface. The waterbody 116 may include small pools of water, sea, lake, river, stream and/or canal etc. that need to be prevented from getting contaminated by sedimentary pollutant(s) 104. The waterbody 116 may be protected from sedimentary pollutant(s) 104 by placing the biobased filtration tube 102 along the perimeter of a site 106 and/or at intervals along the slope 108 around the waterbody 116 to capture and treat stormwater (e.g., stormwater flow 110) before reaching the waterbody 116, according to one embodiment.

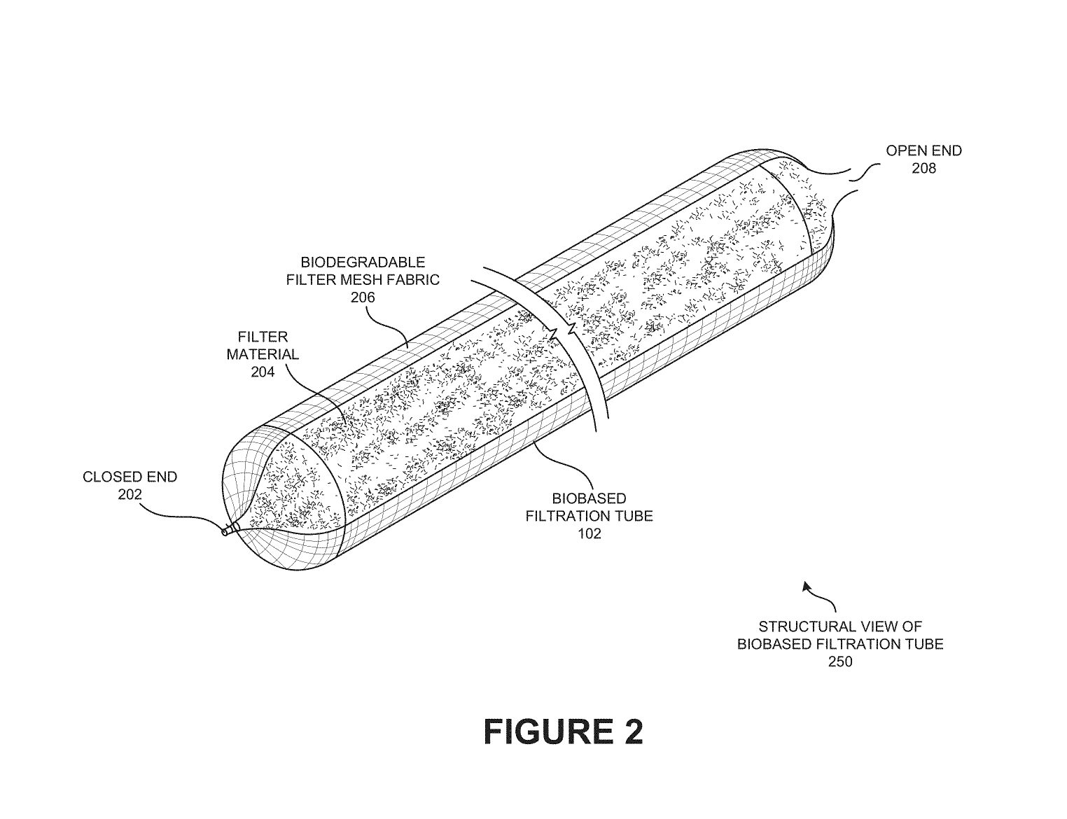

FIG. 2 is a structural view 250 of the biobased filtration tube 102 of FIG. 1 illustrating the formation of the biobased filtration tube 102, according to one embodiment. Particularly, FIG. 2 illustrates a closed end 202, a filter material 204, a biodegradable filter mesh fabric 206, and an open end 208, according to one embodiment.

The closed end 202 may be a distal end of the biobased filtration tube 102 which can be closed and/or sealed prior to the delivery of the filter material 204 into the biobased filtration tube 102. The closed end 202 of the biobased filtration tube 102 may be packed by tying a knot and/or a zip tie. The method of closing and/or sealing of the closed end 202 of the biobased filtration tube 102 may further include knitting, sewing, folding, stapling, clipping, clamping, and/or fastening, etc., according to one embodiment.

The filter material 204 may be a biobased substance delivered into the biobased filtration tube 102 to retain the sedimentary pollutant(s) 104 from getting into the streams causing a growth of algae and green plants in the waterbody 116 (e.g., waterways, lakes and/or oceans). The nontoxic filter material 204 may be delivered into the open end 208 of the biobased filtration tube 102 after sealing of the closed end 202 till the desired length, compaction, and/or the density of the biobased filtration tube 102 is reached. The filter nontoxic material 204 may enable the biobased filtration tube 102 to retain the sedimentary pollutant(s) 104 from the sheet flow 112. The nontoxic filter material 204 may be made up of herbaceous perennial plant and/or switchgrass material. The filter material 204 may further include a substrate such as compost, mulch, gravel, bark, fibers, etc. The filter material 204 may have a particle size optimized to reduce velocity of the sheet flow 112 while trapping the unwanted pollutants, according to one embodiment.

The biodegradable filter mesh fabric 206 may be a material of manufacturing of the biobased filtration tube 102 designed to receive the nontoxic filter material 204 into the biobased filtration tube 102 and help retain and/or contain the sedimentary pollutant(s) 104. The biodegradable filter mesh fabric 206 may be manufactured from the renewable domestic agricultural material such as a plant, an animal, a marine material, cotton, and/or a forestry material. The biodegradable filter mesh fabric 206 (e.g., cotton fabric) of the biobased filtration tube 102 may be naturally degraded into a surrounding environment. The biodegradable filter mesh fabric 206 of biobased filtration tube 102 may have the diameter varying from 4″ inches and above. The material of the biodegradable filter mesh fabric 206 (e.g., cotton fabric) may be flexible and/or fillable. The biodegradable filter mesh fabric 206 may be constructed from a 100% cotton biopreferred sock and/or a photo-degradable material to naturally degrade over time. In addition, the biobased filtration tube 102 may be constructed of a sturdy polypropylene geotextile woven fabric and/or cotton fabric, according to one embodiment.

The open end 208 may be a proximal end of the biobased filtration tube 102 to deliver the nontoxic filter material 204 into the biobased filtration tube 102. The nontoxic filter material 204 may be delivered from the open end 208 till the desired length, compaction, and/or density of the biobased filtration tube 102 is reached. A user may apply force inside the biobased filtration tube 102 from the open end 208 to acquire the desired compaction and/or density when a compaction and/or density of the biobased filtration tube 102 is less than the desired compaction and/or density, according to one embodiment.

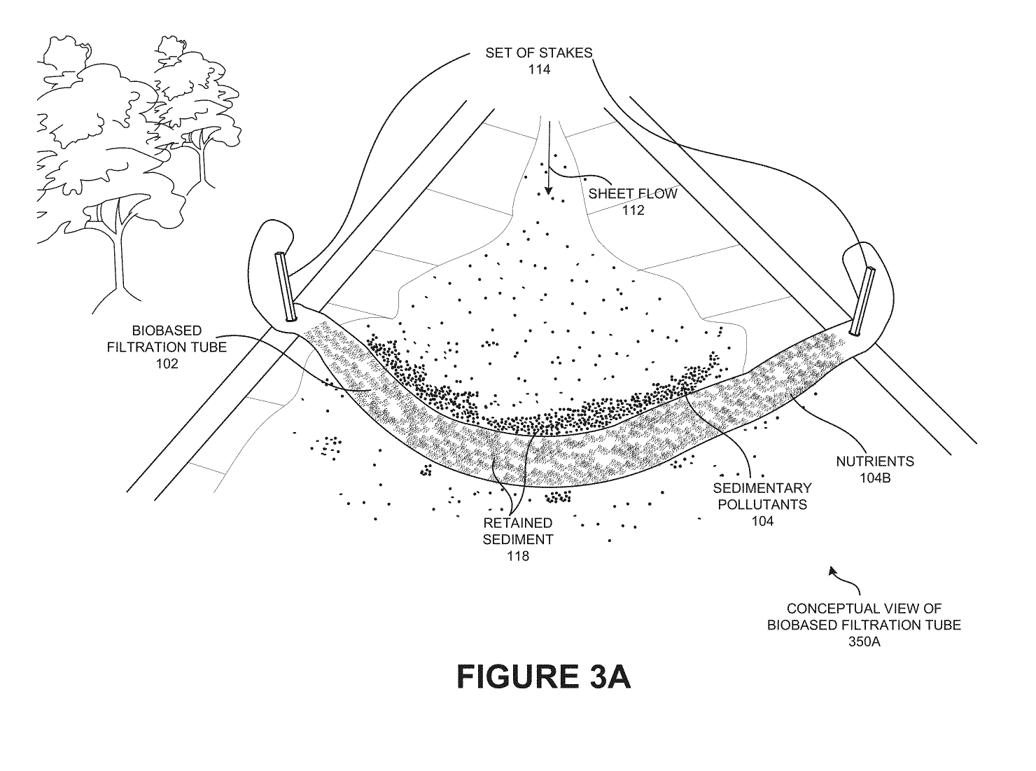

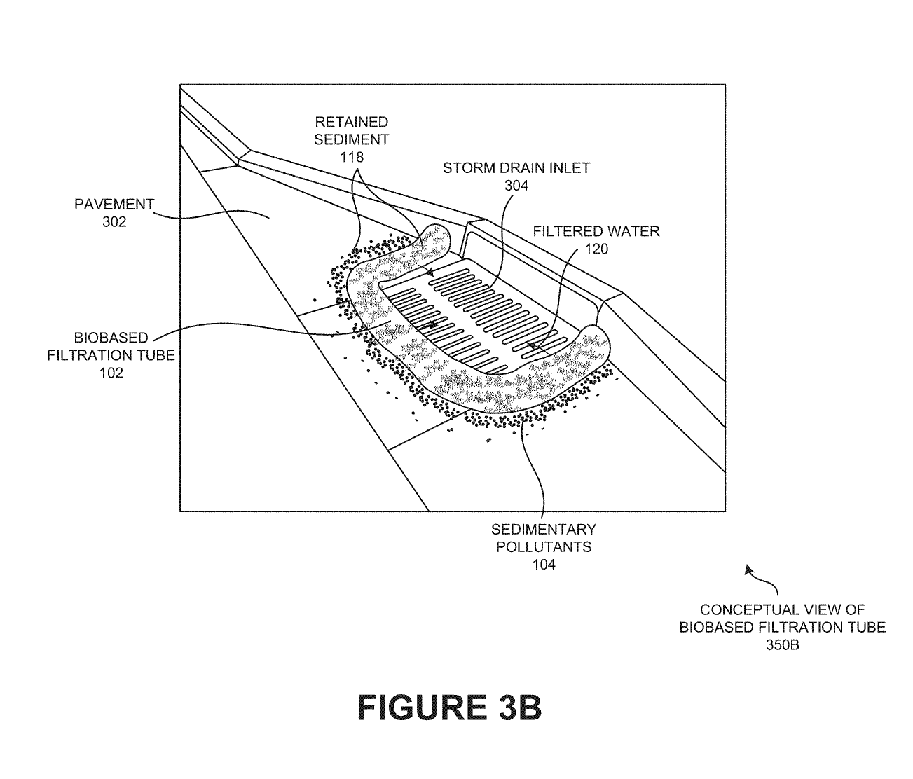

FIG. 3A is a conceptual view 350A of the biobased filtration tube 102 of FIG. 1 illustrating the biobased filtration tube 102 retaining the nutrients and/or sedimentary pollutant(s) 104 from a sheet flow 112, according to one embodiment. FIG. 3A shows the biobased filtration tube 102 placed perpendicular to the sheet flow 112. The set of stakes 114 may be driven through a center of, and/or on both sides of, the biobased filtration tube 102. The biobased filtration tube 102 may enable to reduce velocity and soil erosion of the sheet flow 112. The sedimentary pollutant(s) 104 may be retained on either side of the biobased filtration tube 102 allowing the sheet flow 112 to pass through the biobased filtration tube 102. The biobased filtration tube 102 may be sliced open and the nontoxic filter material spread around a site 106 as a soil material when a project is complete, according to one embodiment.

FIG. 3B is another conceptual view 350B of the biobased filtration tube 102 of FIG. 1 illustrating the biobased filtration tube 102 retaining the nutrients and/or sedimentary pollutant(s) 104 from getting into a storm drain inlet 304 on a pavement 302, according to one embodiment. Particularly, FIG. 3B illustrates a pavement 302, and a storm drain inlet 304, according to one embodiment.

The pavement 302 may be a walkway along the side of a road with the storm drain inlet 304. The storm drain inlet 304 may help to remove the water from the road and its surroundings. FIG. 3B shows the storm drain inlet 304 surrounded with the biobased filtration tube 102 as inlet protection. The biobased filtration tube 102 may help to minimize the erosion of the road prism by runoff from road surfaces. The nontoxic filter material 204 of the biobased filtration tube 102 may obstruct the sediment (e.g., sedimentary pollutant(s) 104) and allow the water flow (e.g., sheet flow 112) to pass through the biobased filtration tube 102. Further, the biobased filtration tube 102 may be used to reduce the water flow velocity (e.g., sheet flow 112) in small ditches, according to one embodiment.

FIG. 4 is a stacking view of the biobased filtration tube 102 of FIG. 1 illustrating the loading of the biobased filtration tube 102 on a pallet 402, according to one embodiment. Particularly, FIG. 4 illustrates a pallet 402, according to one embodiment.

FIG. 4 shows the biobased filtration tubes 102 stacked on top of other biobased filtration tubes 102. The pallet 402 may be a portable platform for handling, storing, and/or transporting the biobased filtration tube 102. The pallet 402 may enable the biobased filtration tube 102 to store without installation for at least 8 months without degradation, according to one embodiment.

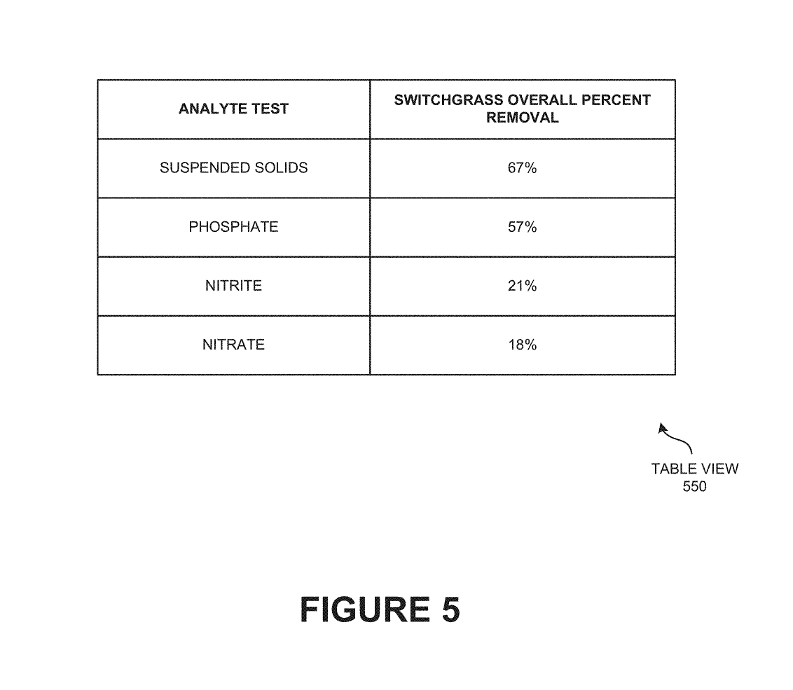

FIG. 5 is a table view of the biobased filtration tube 102 of FIG. 1 showing an analytical test result of the sedimentary pollutant(s) 104 retained by the biobased filtration tube 102, according to one embodiment. FIG. 5 illustrates the type of the sedimentary pollutant(s) 104 and retention percentage of the sedimentary pollutant(s) 104 by the biobased filtration tube 102. The usage of the biobased filtration tube 102 may retain 67% of the suspended solid, 57% of the phosphate, 21% of the nitrate, and 18% of the nitrate from the sheet flow 112, according to one embodiment.

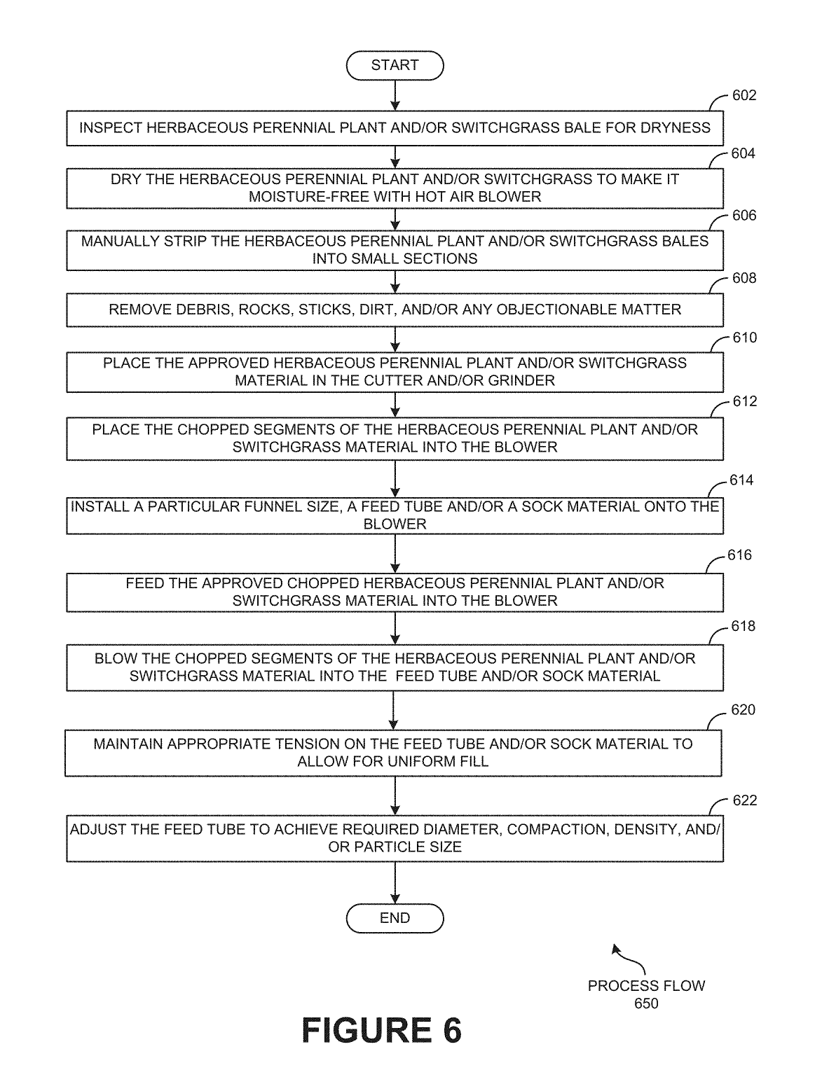

FIG. 6 is a process flow of manufacturing of the biobased filtration tube 102 of FIG. 1, according to one embodiment. In operation 602, the nontoxic herbaceous perennial plant and/or switchgrass bale (e.g., filter material 204) may be inspected for dryness. In operation 604, the nontoxic herbaceous perennial plant and/or switchgrass bale (e.g., filter material 204) may be dried to make it moisture-free with a hot air blower. In operation 606, the nontoxic herbaceous perennial plant and/or switchgrass bale (e.g., filter material 204) may be manually stripped into small sections. In operation 608, the debris, rocks, sticks, dirt, and/or any objectionable substance that is wet may be removed from the nontoxic herbaceous perennial plant and/or switchgrass bale (e.g., filter material 204). In operation 610, the approved nontoxic herbaceous perennial plant and/or switchgrass material (e.g., filter material 204) may be placed in the cutter. In operation 612, the chopped segments of the nontoxic herbaceous perennial plant and/or switchgrass material (e.g., filter material 204) may be placed into the blower. In operation 614, the feed tube and/or sock material (e.g., biobased filtration tube 102) and funnel size may be installed onto the blower, according to one embodiment.

In operation 616, the approved nontoxic chopped nontoxic herbaceous perennial plant and/or switchgrass material may be fed into the blower. In operation 618, the chopped segments of the nontoxic herbaceous perennial plant and/or switchgrass material (e.g., filter material 204) may be blown into the feed tube and/or sock material (e.g., biobased filtration tube 102). In operation 620, an appropriate tension may be maintained on the feed tube and/or sock material (e.g., biobased filtration tube 102) to allow uniform fill for compaction and density requirements. In operation 622, the feed tube (e.g., biobased filtration tube 102) may be adjusted to achieve required diameter, compaction, density, and/or particle size, according to one embodiment.

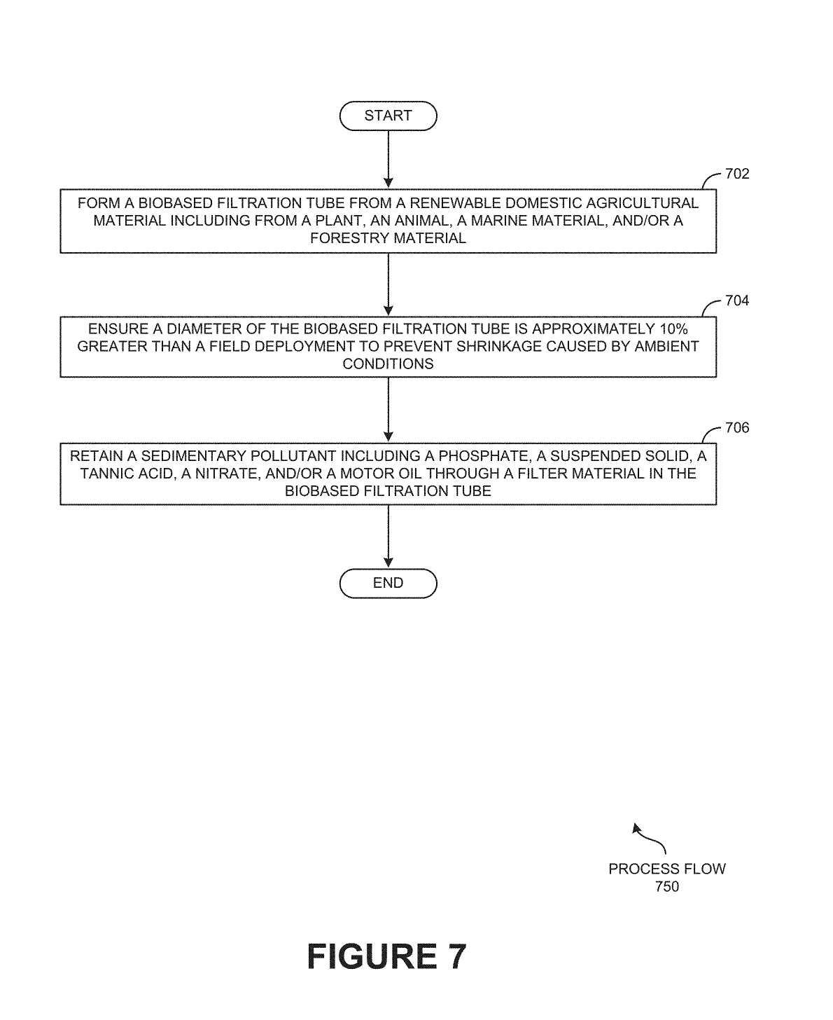

FIG. 7 is a process flow for application of watershed stormwater management system 150 using the biobased filtration tube 102 of FIG. 1, according to one embodiment. In operation 702, a biobased filtration tube 102 may be formed from a nontoxic renewable domestic agricultural material including from a plant, an animal, a marine material, and/or a forestry material. In operation 704, a diameter of the biobased filtration tube 102 may be ensured to have approximately 10% greater than a field deployment to allow and account for shrinkage caused by ambient conditions. In operation 706, a sedimentary pollutant(s) 104 including a phosphate, a suspended solid, a tannic acid, a nitrate, and/or a motor oil may be retained through a filter material 204 in the biobased filtration tube 102. The biobased filtration tube 102 may be placed along the perimeter of a site 106, and/or at intervals along a slope 108 to capture and treat stormwater (e.g., stormwater flow 110) that runs off as the sheet flow.

According to one example embodiment, the biobased filtration tube 102 may be placed in the direction of flow of water to allow stormwater to flow through the circular cross section of the biobased filtration tube 102.

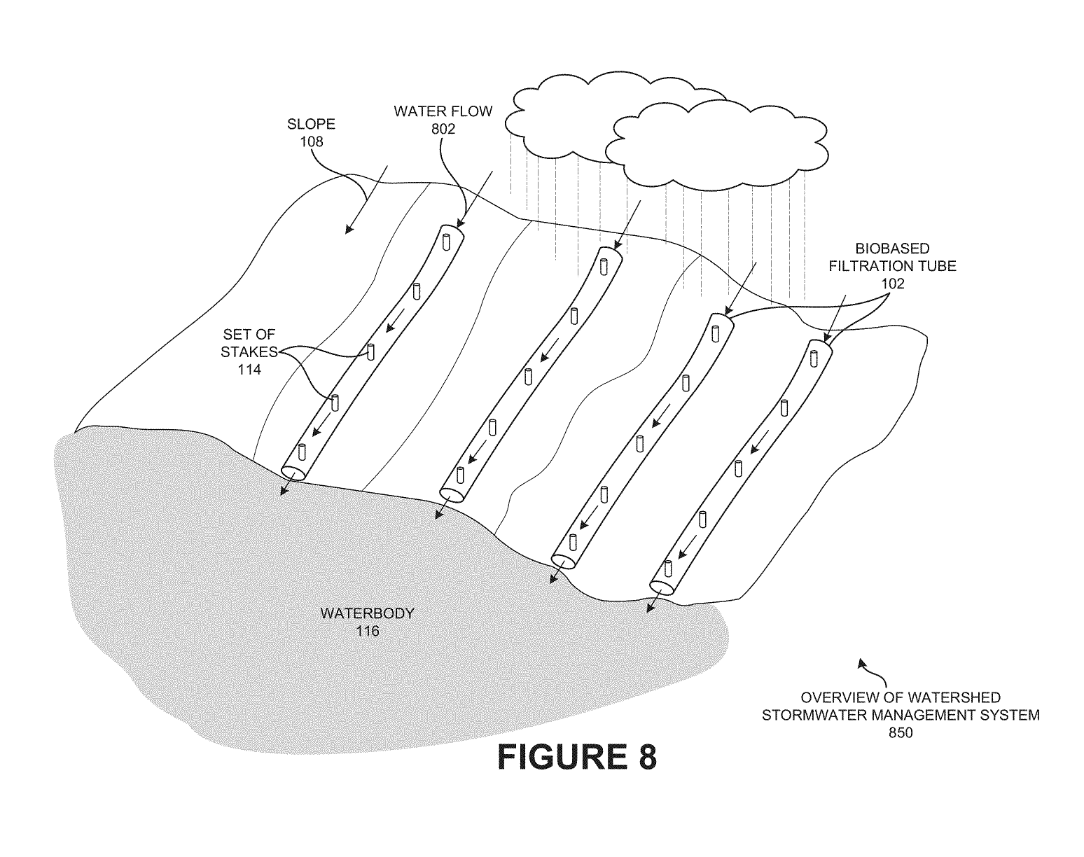

FIG. 8 is an example overview 850 of an alternate implementation of the watershed stormwater management system illustrating the biobased filtration tube 102 of FIG. 1 retaining nutrients 104B and sedimentary pollutants 104 inside the tube and allowing passage of filtered water 120 to prevent the nutrients and/or pollutants getting into the waterbody 116 when placed in the direction of water flow 802, according to one embodiment.

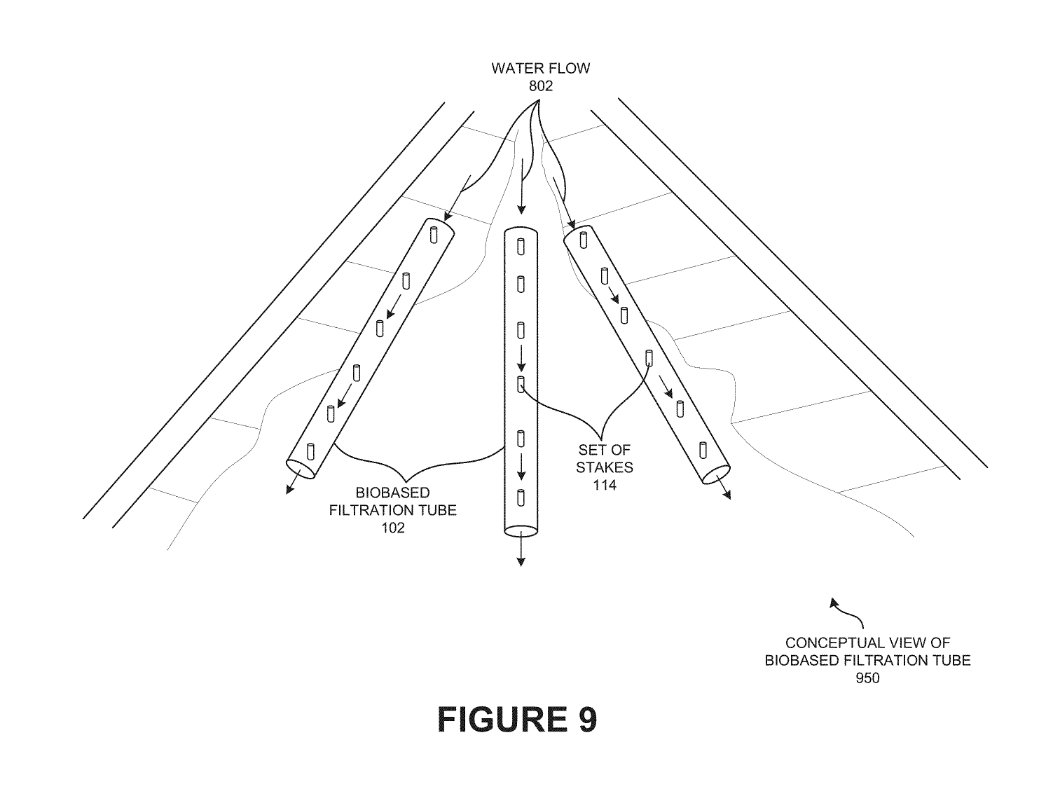

FIG. 9 is a conceptual view 950 of the biobased filtration tube 102 of FIG. 1 illustrating the biobased filtration tube 102 retaining the nutrients and/or sedimentary pollutant 104 from the sheet flow 112 when placed in the direction of water flow 802. The alternate implementation of the biobased filtration tube 102 may allow water to flow through its circular cross-section when placed in the direction of water flow 802, according to one embodiment.

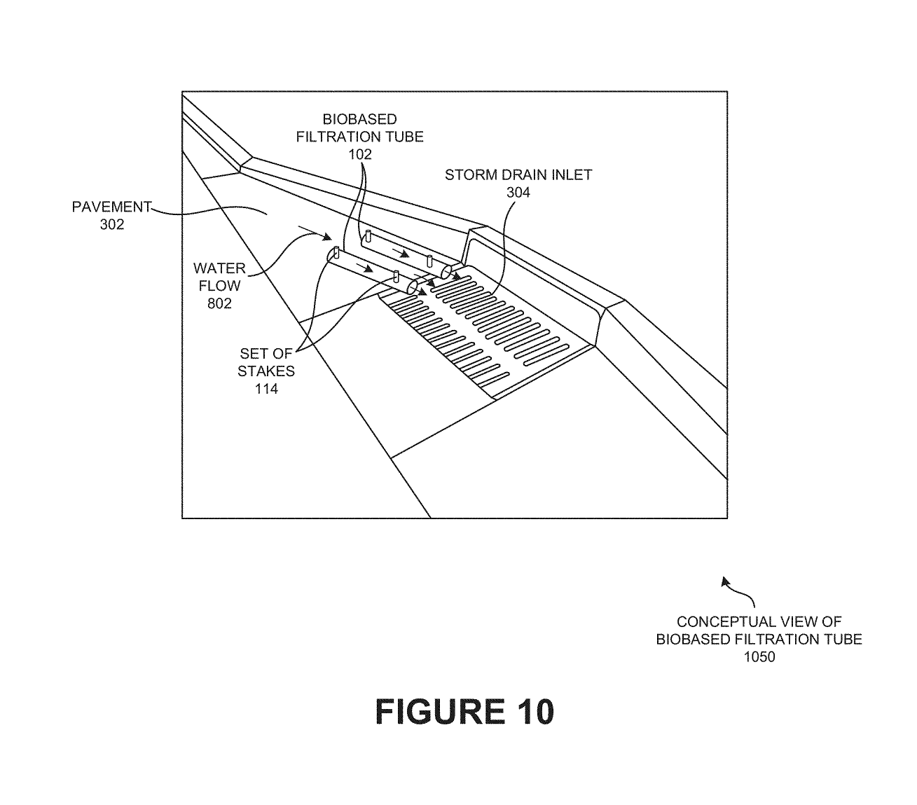

FIG. 10 is another conceptual view 1050 in an alternative implementation of the biobased filtration tube 102 of FIG. 1 illustrating the biobased filtration tube retaining 102 the nutrients and/or the sedimentary pollutants 104 from getting into the storm drain inlet 304 on the pavement 302. The nutrients and/or the sedimentary pollutants 104 may be prevented from getting into the storm drain inlet 304 on the pavement 302 by placing the biobased filtration tube 102 in the direction of flow of water 802, in according to one embodiment.

In an alternate embodiment, a method of a watershed stormwater management system includes forming a sediment retaining water filtration tube from a renewable domestic agricultural material including from a plant, an animal, a marine material, and/or a forestry material. The method of the watershed stormwater management system includes manufacturing a diameter of the SRWF tube is approximately 10% greater than a field deployment to allow and account for shrinkage caused by settling in ambient conditions.

Further, the method of the watershed stormwater management system includes retaining a sedimentary pollutant including a phosphate, a suspended solid, a tannic acid, a nitrate, and/or a motor oil through a nontoxic filter material in the SRWF tube. The nontoxic filter material in the SRWF tube permits filtration of clear water to pass through but retains the sedimentary pollutant so they do not get into the streams causing growth of algae and green plants in waterways, lakes, and oceans. The biobased SRWF tube has a shape which is an oval shape and/or a round shape or any polygonal cross-section. The biobased filtration tube provides a three-dimensional filter to retain sedimentary pollutant and other pollutants while filtering water and permitting filtered water to flow through the biobased SRWF tube.

In addition, the method of the watershed stormwater management system includes placing the biobased SRWF tube along the perimeter of a site and/or at intervals along a slope to capture and treat stormwater that runs off as a sheet flow. The biobased SRWF tube has a greater surface area contact with soil than other sediment control devices to reduce a potential for runoff to create rills under the biobased SRWF tube and to create channels for carrying unfiltered sediment. The biobased SRWF tube is operable in a vegetated form and/or an un-vegetated form. Vegetation grows into the slope anchoring the biobased filtration tube in an environment when the biobased filtration tube is utilized in the vegetated form.

The method of a watershed stormwater management system may include reducing flow velocity and soil erosion by placing the biobased SRWF tube perpendicular to the stormwater flow. As an alternate embodiment, the biobased SRWF tube it may be placed along the stormwater flow. The SRWF tube may be usable on a pavement as inlet protection for storm drains and to slow water flow in small ditches. A filler material used to fill the tube is also called filter material in the following text. The biobased SRWF tube nontoxic filler material may be spreadable around the site as a soil material when a project is completed and the biobased filtration tube is sliced. A filter mesh and/or cotton fabric of the biobased filtration tube may be naturally degraded into a surrounding environment.

The biobased SRWF tube may be installable without need of trenching. The biobased SRWF tube may be stackable on top of other biobased SRWF tubes. The biobased SRWF tube may be filled with the nontoxic filter material with a particle size optimized to reduce velocity while trapping unwanted pollutants. The biobased SRWF tube may be assembled by tying a knot and/or a zip tie at one end of a mesh and/or cotton fabric, filling the biobased SRWF tube with the nontoxic filter material, and securing an opposite end once a desired length is reached. The biobased SRWF tube may be anchored to the slope through peripheral clamps anchored to the ground or stakes driven through a center of, and/or on both sides of, the biobased SRWF tube at regular intervals. The biobased SRWF tube may be used in conjunction with a hydro-seeding process, a matting/netting process, and/or a compost blanket process.

In another aspect, a watershed stormwater management system includes a biobased SRWF tube comprised of nontoxic herbaceous perennial plant and/or switchgrass material. The biobased SRWF tube is 100% composed of a nontoxic biological product and/or a renewable domestic agricultural material included from a plant, an animal, a marine material, and/or a forestry material. The biobased SRWF tube is sustainable in a field deployment without minimal degradation for at least ten (10) months for the mesh fabric and at least five (5) months for the cotton fabric across extreme conditions of snow, rain and temperature range between 20° F. and 100° F. The biobased SRWF tube is manufactured with a diameter that is approximately 10% greater than the field deployment to allow shrinkage caused by settling in ambient conditions.

The biobased SRWF tube may be an alternative to compost in a furnishing, a placement, a maintenance of a compost filter sock erosion and/or a sedimentation pollution control system. The biobased SRWF tube may be constructed in various sizes from the diameter of 4″ inches and above. The biobased SRWF tube may be storable without installation for at least 8 months on a pallet in external conditions without degradation. The biobased SRWF tube may retain sedimentary pollutants including a phosphate, a suspended solid, a tannic acid, a nitrate, arsenic and/or a motor oil through a nontoxic filter material.

The nontoxic filter material in the biobased SRWF tube prevents the high concentration of the sedimentary pollutant from getting into the streams causing growth of algae and green plants in waterways, lakes, and oceans. The biobased SRWF tube may be constructed from a 100% cotton biopreferred sock and/or a photo-degradable material which naturally degrades over-time. The biobased filtration tube may be constructed of a sturdy biobased geotextile woven fabric and/or cotton fabric to control erosion, contain sediment, and retain sedimentary pollutant in disturbed areas. The biobased filtration tube may be a mesh and/or cotton tube filled with a nontoxic biobased material placed perpendicular to sheet-flow runoff.

The biobased SRWF tube may be used instead of a traditional sediment and an erosion control tool as a silt fence, a straw bale barrier and a mulch sock. The biobased SRWF tube may be placed along the perimeter of a site, and/or at intervals along a slope to capture and treat stormwater that runs off as a sheet flow. The biobased SRWF tube may be flexible, fillable, and easily movable into position to facilitate placement on steep and rocky slopes where installation of other erosion control tools is not feasible.

The biobased SRWF tubes may be placeable adjacent to each other and perpendicular to stormwater flow to reduce flow velocity and soil erosion. The biobased SRWF tube may be manufactured through a process that converts nontoxic herbaceous perennial plant and/or switchgrass agricultural bi-product into a dry bulk density biomass of at least 1.6 g/cm3 through a smooth compaction roller and forming a porous sheet having a thickness of approximately 1 inch that is rolled into a form of the biobased filtration tube.

In yet another aspect, a method of a watershed stormwater management system includes forming a biobased SRWF tube from a renewable domestic agricultural material including from a plant, an animal, a marine material, and/or a forestry material. The method of a watershed stormwater management system includes ensuring a diameter of the biobased SRWF tube is approximately 10% greater than a field deployment to allow shrinkage caused by settling in ambient conditions.

The method of a watershed stormwater management system includes retaining nutrients and sedimentary pollutants including a phosphate, a suspended solid, a tannic acid, a nitrate, nitrite and/or a sediment such as motor oil, or arsenic through a filter material in the biobased SRWF tube. The filter material in the biobased SRWF tube prevents the high concentrations of the sedimentary pollutant from getting into the streams and thus prevents growth of algae and green plants in waterways, lakes, and oceans. The biobased SRWF tube has a shape which is an oval shape and/or a round shape or any polygon section. The biobased filtration tube provides a three-dimensional filter to retain sediment and other pollutants while purifying water and permitting purified water to flow through the biobased filtration tube.

Further, the method of a watershed stormwater management system includes placing the biobased SRWF tube along the perimeter of a site, and/or at intervals along a slope to capture and treat stormwater that runs off as sheet flow. In addition, the method of a watershed stormwater management system includes reducing flow velocity and soil erosion by placing the biobased SRWF tube perpendicular to stormwater flow.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A method of a watershed stormwater management system, comprising:
forming a biobased filtration tube from a renewable domestic agricultural material including from any one of a plant, an animal, a marine material, and a forestry material;
ensuring that a diameter of the biobased filtration tube is approximately 10% greater than a field deployment to allow and account for shrinkage caused by ambient conditions;
retaining a sedimentary pollutant including any one of a phosphate, a suspended solid, a tannic acid, a nitrate, and a motor oil through a filter material in the biobased filtration tube to help prevent high concentrations of the sedimentary pollutant from getting into the streams causing growth of algae and green plants in waterways, lakes and oceans,
wherein the biobased filtration tube to have a shape which is either one of an oval shape and a round shape in cross section, to provide a three-dimensional filter that retains sedimentary pollutant and other pollutants while purifying water and permitting it to flow through the biobased filtration tube; and
placing the biobased filtration tube either along the perimeter of a site, and alternatively at intervals along a slope to capture and treat stormwater that runs off as a sheet flow that is a downslope movement of water taking a form of a thin, continuous film over relatively smooth surfaces and not concentrated into channels larger than a rill,
wherein the biobased filtration tube to have a greater surface area contact with soil than other sediment control devices thereby reducing a potential for runoff to create rills under the biobased filtration tube and thereby creating channels carrying unfiltered sediment, and
wherein the biobased filtration tube is operable in either one of a vegetated form and an un-vegetated form, and wherein when the biobased filtration tube is utilized in the vegetated form, a vegetation to grow into the slope further anchoring the biobased filtration tube in an environment.

2. The method of claim 1 further comprising reducing flow velocity and soil erosion by placing the biobased filtration tube perpendicular to stormwater flow.

3. The watershed stormwater management system of claim 1 wherein the watershed stormwater management system is usable on a pavement as inlet protection for storm drains and to slow water flow in small ditches.

4. The watershed stormwater management system of claim 1 wherein the biobased filtration tube is spreadable around the site as a soil material when a project is completed and the biobased filtration tube is sliced, and wherein a filter mesh fabric of the biobased filtration tube is naturally degraded into a surrounding environment.

5. The watershed stormwater management system of claim 1 wherein the biobased filtration tube is installable without need of trenching thereby leaving a soil surface undisturbed.

6. The watershed stormwater management system of claim 1 wherein the biobased filtration tube is stackable on top of each other biobased filtration tubes.

7. The watershed stormwater management system of claim 1 wherein the biobased filtration tube is filled with the nontoxic filter material with a particle size optimized to reduce velocity while trapping unwanted pollutants.

8. The watershed stormwater management system of claim 7 wherein the biobased filtration tube is assembled by tying at least one of a knot and a zip tie at one end of a mesh, filling the biobased filtration tube with the nontoxic filter material, and securing an opposite end once a desired length is reached.

9. The watershed stormwater management system of claim 8 wherein the biobased filtration tube is anchored to the slope through a set of stakes driven through at least one of a center and on both sides of the biobased filtration tube at regular intervals.

10. The watershed stormwater management system of claim 9 wherein the biobased filtration tube is used in conjunction with at least one of a hydro-seeding process, a matting/netting process, and a compost blanket process.

11. A watershed stormwater management system, comprising:
a biobased filtration tube comprised of at least one of a nontoxic herbaceous perennial plant and switchgrass material,
wherein the biobased filtration tube is 100% composed of at least one of a biological product and a nontoxic renewable domestic agricultural material including from any one of a plant, an animal, a marine material, nontoxic herbaceous perennial plant, and a forestry material,
wherein the biobased filtration tube is sustainable in a field deployment without minimal degradation for at least ten (10) months for the mesh fabric and at least five (5) months for a cotton fabric across extreme conditions of snow, rain and temperature ranges between at least 20° F. and 100° F., and
wherein the biobased filtration tube is manufactured with a diameter that is approximately 10% greater than the field deployment to allow and account for shrinkage caused by ambient conditions.

12. The watershed stormwater management system of claim 11 wherein the biobased filtration tube is an alternative to compost in at least one of a furnishing, a placement, a maintenance of a compost filter sock erosion and a sedimentation pollution control system.

13. The watershed stormwater management system of claim 11 wherein a desired density of the biobased filtration tube is approximately 0.096 g/cm3.

14. The watershed stormwater management system of claim 13 wherein a user to apply force inside the biobased filtration tube from an open end to acquire the desired compaction and density when a compaction and density of the biobased filtration tube is less than the desired compaction and density.

15. The watershed stormwater management system of claim 12 wherein the biobased filtration tube is constructed in various sizes from the diameter of 4″ inches and above.

16. The watershed stormwater management system of claim 13 wherein the biobased filtration tube is storable without installation for at least 8 months on a pallet in external conditions without degradation.

17. The watershed stormwater management system of claim 11 wherein the biobased filtration tube retains sedimentary pollutant including any one of a phosphate, a suspended solid, a tannic acid, a nitrate, and a motor oil through a nontoxic filter material to help prevent high concentrations of the sedimentary pollutant from getting into the streams causing growth of algae and green plants in waterways, lakes and oceans.

18. The watershed stormwater management system of claim 11 wherein the biobased filtration tube is optionally constructed from at least one of a 100% cotton biopreferred sock and a photo-degradable material which naturally degrades over time.

19. The watershed stormwater management system of claim 11, wherein the biobased filtration tube is constructed of at least one of a sturdy polypropylene geotextile woven fabric and cotton fabric that is engineered specifically to control erosion, contain sediment, and retain sedimentary pollutant in disturbed areas.

20. The watershed stormwater management system of claim 11, wherein the biobased filtration tube is at least one of a mesh and cotton tube filled with a nontoxic biobased material placed perpendicular to sheet-flow runoff.

21. The watershed stormwater management system of claim 11, wherein the biobased filtration tube to have a shape which is either one of an oval shape and a round shape in cross section, to provide a three-dimensional filter that retains sediment and other pollutants while purifying water and permitting it to flow through the biobased filtration tube.

22. The watershed stormwater management system of claim 11 wherein the biobased filtration tube is used in place of a traditional sediment and an erosion control tool as a silt fence, a straw bale barrier and a mulch sock.

23. The watershed stormwater management system of claim 11 wherein the biobased filtration tube is placed either along the perimeter of a site, and alternatively at intervals along a slope to capture and treat stormwater that runs off as a sheet flow, and wherein the sheet flow is a downslope movement of water taking a form of a thin, continuous film over relatively smooth surfaces and not concentrated into channels larger than a rill.

24. The watershed stormwater management system of claim 11 wherein the biobased filtration tube is flexible, fillable, and easily movable into position to facilitate placement on steep and rocky slopes where installation of other erosion control tools is not feasible.

25. The watershed stormwater management system of claim 11 wherein the biobased filtration tube there is a greater surface area contact with soil than other sediment control devices thereby reducing a potential for runoff to create rills under the biobased filtration tube and thereby creating channels carrying unfiltered sediment.

26. The watershed stormwater management system of claim 11 wherein the biobased filtration tubes are placeable adjacent to each other and perpendicular to stormwater flow to reduce flow velocity and soil erosion.

27. The watershed stormwater management system of claim 11 wherein the watershed stormwater management system is usable on a pavement as inlet protection for storm drains and to slow water flow in small ditches.

28. The watershed stormwater management system of claim 11 wherein the biobased filtration tube is operable in either a vegetated form and an un-vegetated form, and wherein when the biobased filtration tube is utilized in the vegetated form, a vegetation to grow into the slope further anchoring the biobased filtration tube in an environment.

29. The watershed stormwater management system of claim 11 wherein the biobased filtration tube nontoxic filler material is spreadable around the site as a soil material when a project is completed and the biobased filtration tube is sliced, and wherein a filter mesh fabric and cotton fabric of the biobased filtration tube is naturally degraded into a surrounding environment.

30. The watershed stormwater management system of claim 11 wherein the biobased filtration tube is installable without need of trenching thereby leaving a soil surface undisturbed.

31. The watershed stormwater management system of claim 11 wherein the biobased filtration tube is stackable on top of each other biobased filtration tubes.

32. The watershed stormwater management system of claim 11 wherein the biobased filtration tube is filled with the nontoxic filter material with a particle size optimized to reduce velocity while trapping unwanted pollutants.

33. The watershed stormwater management system of claim 30, wherein the biobased filtration tube is assembled by tying at least one of a knot and a zip tie at one end of a mesh and cotton fabric, filling the biobased filtration tube with the filter material, and securing an opposite end once a desired length is reached.

34. The watershed stormwater management system of claim 31, wherein the biobased filtration tube is anchored to the slope through a set of stakes driven through at least one of a center and on both sides of, the biobased filtration tube at regular intervals.

35. The watershed stormwater management system of claim 32, wherein the biobased filtration tube is used in conjunction with at least one of a hydro-seeding process, a matting/netting process, and a compost blanket process.

36. The watershed stormwater management system of claim 32, wherein the biobased filtration tube is manufactured through a process that converts at least one of the nontoxic herbaceous perennial plant, switchgrass, and an agricultural bi-product into a dry bulk density biomass of at least 1.6 g/cm3 through a smooth compaction roller, and thereby forming a porous sheet having a thickness of approximately 1 inch that is rolled into a form of the biobased filtration tube.

37. A method of a watershed stormwater management system, comprising:
forming a biobased filtration tube from a renewable domestic agricultural material including from any one of a plant, an animal, a marine material, and a forestry material;
ensuring that a diameter of the biobased filtration tube is approximately 10% greater than a field deployment to allow and account for shrinkage caused by ambient conditions;
retaining a sedimentary pollutant including any one of a phosphate, a suspended solid, a tannic acid, a nitrate, and a motor oil through a filter material in the biobased filtration tube to help prevent high concentrations of the sedimentary pollutant from getting into the streams causing growth of algae and green plants in waterways, lakes and oceans,
wherein the biobased filtration tube to have a shape which is either one of an oval shape and a round shape in cross section, to provide a three-dimensional filter that retains sediment and other pollutants while purifying water and permitting it to flow through the biobased filtration tube;
placing the biobased filtration tube either along the perimeter of a site, and alternatively at intervals along a slope to capture and treat stormwater that runs off as sheet flow that is a downslope movement of water taking a form of a thin, continuous film over relatively smooth surfaces and not concentrated into channels larger than a rill; and
reducing flow velocity and soil erosion by placing the biobased filtration tube perpendicular to stormwater flow.

38. The method of claim 35:
wherein the biobased filtration tube to have a greater surface area contact with soil than other sediment control devices thereby reducing a potential for runoff to create rills under the biobased filtration tube and thereby creating channels carrying unfiltered sediment, and
wherein the biobased filtration tube is operable in either one of a vegetated form and an un-vegetated form, and wherein when the biobased filtration tube is utilized in the vegetated form, a vegetation to grow into the slope further anchoring the biobased filtration tube in an environment.

39. The watershed stormwater management system of claim 35, wherein the watershed management system is usable on a pavement as inlet protection for storm drains and to slow water flow in small ditches.

40. The watershed stormwater management system of claim 35, wherein the biobased filtration tube is spreadable around the site as a soil material when a project is completed and the biobased filtration tube is sliced, and wherein a filter mesh fabric and a cotton fabric of the biobased filtration tube is naturally degraded into a surrounding environment.

41. The watershed stormwater management system of claim 35, wherein the biobased filtration tube is installable without need of trenching thereby leaving a soil surface undisturbed.
